(19) United States
(12) Patent Application Publication
(10) Pub. No.: US 2021/0068553 A1
(43) Pub. Date: Mar. 11, 2021

(54) REINFORCED POCKET SPRING MATTRESS

(71) Applicant: IKEA Supply AG, Pratteln (CH)

(72) Inventor: Jocim NYGREN, Almhult (SE)

(73) Assignee: IKEA Supply AG, Pratteln (CH)

(21) Appl. No.: 16/959,463

(22) PCT Filed: Jan. 3, 2019
(86) PCT No.: PCT/SE2019/050002

§ 371 Date: Jul. 1, 2020

(30) Foreign Application Priority Data
Jan. 4, 2018 (SE) 1850010-8

(51) Int. Cl. A47C 27/06; B29D 99/00

(52) U.S. Cl. CPC A47C 27/064; A47C 27/062; B29K 2701/12; B29K 2713/00; B29D 99/00

(57) ABSTRACT

A pocket spring mattress (1) comprising a plurality of double layer spring units (7) arranged in rows and columns to form a rectangular shaped mattress is provided. Each double layer spring unit (7) comprises a first pocket spring unit (2a) arranged axially onto a second pocket spring unit (2b), and each spring unit (2a, 2b) comprises a number of springs (3a-b, 4a-b) and a fabric pocket (6′) enclosing the springs (3a-b, 4a-b). The springs (3a-b, 4a-b) comprises reference springs (3a-b) having a first spring constant and frame springs (4a-b) having a second spring constant being greater than the first spring constant, and frame springs (4a-b) are arranged in at least one of the first and second pocket spring units (2a, 2b) of at least one outermost row or column of the double layered spring units (7) in a configuration such that the edge of the mattress (1) is reinforced.

### TECHNICAL FIELD

The present invention relates to a pocket spring mattress, and more specifically to a reinforced pocket spring mattress comprising two layers of springs.

### PRIOR ART

Pocket spring mattresses are a common type of mattresses, where, most often, coil springs are arranged in fabric material pockets forming elongated spring strings. The spring strings are then arranged side by side thereby providing a mattress with individual springs being held together by the fabric normally made from a nonwoven material. As the techniques for manufacturing mattresses improve, customers have come to expect ever improving performance from new mattresses which are made available on the market. For instance, mattresses are available with zones having varying stiffness to suit different users.

To provide an improved sense of stability and to avoid that a person rolls of the side of the bed, mattresses are commonly designed with a frame or other type of reinforcement around the edges of the mattress. One known example of such frames are for instance a foam box construction, where a polyurethane frame is used to reinforce the edges. Another example is a steel frame construction. As many modern mattresses comprises two layers of springs, the complexity to achieve sufficient edge reinforcement for the mattresses increase. An alternative to the prior art solutions is therefore sought after, which provides improved performance at a lower cost.

### SUMMARY

It is an object of the invention to at least partly overcome one or more of the above-identified limitations of the prior art. In particular, it is an object to provide a mattress which costs less to produce, a method for manufacturing the mattress, and a machine configured to perform the method for manufacturing the mattress.

According to one aspect of the invention a pocket spring mattress is provided. The mattress comprises a plurality of double layer spring units arranged in rows and columns to form a rectangular shaped mattress, each double layer spring unit comprises a first pocket spring unit arranged axially onto a second pocket spring unit. Each spring unit comprises a number of springs and a fabric pocket enclosing the springs. The springs comprises reference springs having a first spring constant and frame springs having a second spring constant being greater than the first spring constant, and the frame springs are arranged in at least one of the first and second pocket spring units of at least one outermost row or column of the double layered spring units. The edge(s) of the double layered mattress can in this way be reinforced in an inexpensive way, without use of additional components such as frames or wires. Preferably, the frame springs are arranged in at least one of the first and second pocket spring units of at least one outermost row or column of the double layered spring units in a configuration such that the edge of the mattress is reinforced.

In an embodiment, the frame springs are arranged in at least one of the first and second pocket spring units of at least one outermost row or column of the double layered spring units in a configuration such that only the edge of the mattress is reinforced.

A series of adjacent double layer spring units may be attached to each other to form an elongated spring string, simplifying the manufacturing of the mattress.

Each spring string may further be arranged side by side with another spring string forming an upper spring layer formed by the first pocket spring units, and a lower spring layer formed by the second pocket spring units.

Frame springs may be arranged in at least one of the first and second pocket spring units of at least two adjacent outermost rows or columns of the double layered spring units.

Frame springs may furthermore be arranged only in the first pocket spring units of two adjacent outermost rows and columns of the double layered spring units, forming a reinforced edge around the circumference of the mattress.

In one embodiment, frame springs may be arranged only in the second pocket spring units of two adjacent outermost rows and columns of the double layered spring units, forming a reinforced edge around the circumference of the mattress.

The second spring constant of the frame springs may be at least 15%, and preferably at least 30% higher than the first spring constant of the reference springs.

Furthermore, a material of the fabric pocket may be a nonwoven fabric material comprising thermoplastic material.

In one embodiment, each spring string comprises between 10 and 50 double layered spring units per meter of spring string, preferably between 10 and 20, even more preferably in the range of 15 double layered spring units per meter of spring string and wherein each spring string is attached by means of an adhesive, preferably hot melt adhesive, side by side to another spring string.

In a second aspect, a method for manufacturing a plurality of double layer spring units arranged in a spring string configured to form a mattress according to the first aspect is provided. The method comprises the steps of: determining if a reference wire or a frame wire is to be used to form upper spring of the first pocket spring units and if a reference wire or a frame wire is to be used to form lower spring of the second pocket spring units; feeding the determined upper wire and the determined lower wire; heating the determined wires; bending the determined upper wire and the determined lower wire; cutting each wire to form an upper spring and a lower spring; placing each spring in a fabric pocket; and sealing the pockets by means of welding forming a double layer spring unit. As the manufacturing method allows for use of two different wires for each layer of the mattress, each double layered spring unit can be varied in four different stiffness levels depending on the chosen wire for each layer. This is achieved in a single manufacturing process which provides a high manufacturing rate whilst accomplishing a complex mattress with reinforced edge(s).

In one embodiment, the method comprises arranging the upper spring and the lower spring in a common pocket, and sealing the pocket around the springs and between the upper spring and the lower spring thereby forming one pocket for the upper layer and one pocket for the lower layer, thus forming two pocket spring units together forming the double layer spring unit. Placing both springs in a larger pocket or sleeve in the fabric and subsequently sealing and thus separating the springs into two pockets is beneficial as the springs are securely held in the respective pockets above each other and will not cause any noise or wear due to two springs coming into contact with each other.

The fabric material may be cut to form a spring string after a predetermined number of double layered spring units are formed.

Each spring string may be attached by means of an adhesive, preferably hot melt adhesive, side by side to another spring string, and between 10 and 50 double layered spring units per meter of spring string, preferably between 10 and 20, even more preferably in the range of 14 spring strings may form a pocket spring mattress with a width of 90 cm.

The pockets may be sealed by means of ultra-sonic welding.

In a third aspect of the teachings herein, a machine for manufacturing a pocket spring mattress is provided. The machine comprises: determining means for determining which upper layer wire and which lower layer wire to be used; feeding means for feeding the determined upper layer wire and the determined lower layer wire; heating means for heating the determined wires; bending means for bending the upper layer wire and for bending the lower layer wire; cutting means for cutting the determined wires to form an upper layer spring and a lower layer spring; placing means for placing each spring in a fabric pocket; and welding means for sealing the pockets forming a double layered spring unit. The machine allows for a great number of possible variations in the mattresses manufactured therein.

The machine may further comprise fabric feeding means for feeding fabric material through the machine.

The machine may also comprise attachment means for attaching each spring string by means of an adhesive, preferably hot melt adhesive, side by side to another spring string. Between 13 to 15 spring strings, preferably 14 spring strings form a pocket spring mattress.

Further objects and advantages of the present invention will be obvious to a person skilled in the art when reading the detailed description below of different embodiments.

### BRIEF DESCRIPTION OF THE DRAWINGS

The present invention will be described further below by way of example and with reference to the enclosed drawings. In the drawings:

FIG. 1 is a perspective view of the mattress according to one embodiment,

FIG. 2 is a top view of the mattress according to one embodiment,

FIG. 3 is a perspective view of one corner of the mattress according to one embodiment where the springs are visible, and

FIGS. 4-6 are schematic outlines of methods according to embodiments.

### DETAILED DESCRIPTION OF EMBODIMENTS

In the following a mattress 1 will be described. As used in this description the expression “longitudinal” refers to the direction of the length of the mattress, i.e. the normal feet-to-head direction of a person lying on the mattress 1. The expression “transversal” refers to the direction of the width of the mattress. The longitudinal and transversal directions are at right angles to each other. The mattress has normally a rectangular form as seen from above. Thus, the length of the mattress corresponds to the longer sides of the rectangle and the width of the mattress corresponds to the shorter sides of the rectangle. It is for instance common to have mattresses with a length of 200 cm and a width of 90 cm. The terms “upper” and “lower” are used to define the normal position of the mattress 1, i.e. having an upper side onto which the person using the mattress 1 is intended to rest upon, and a lower side forming the underside of the mattress 1 during normal use.

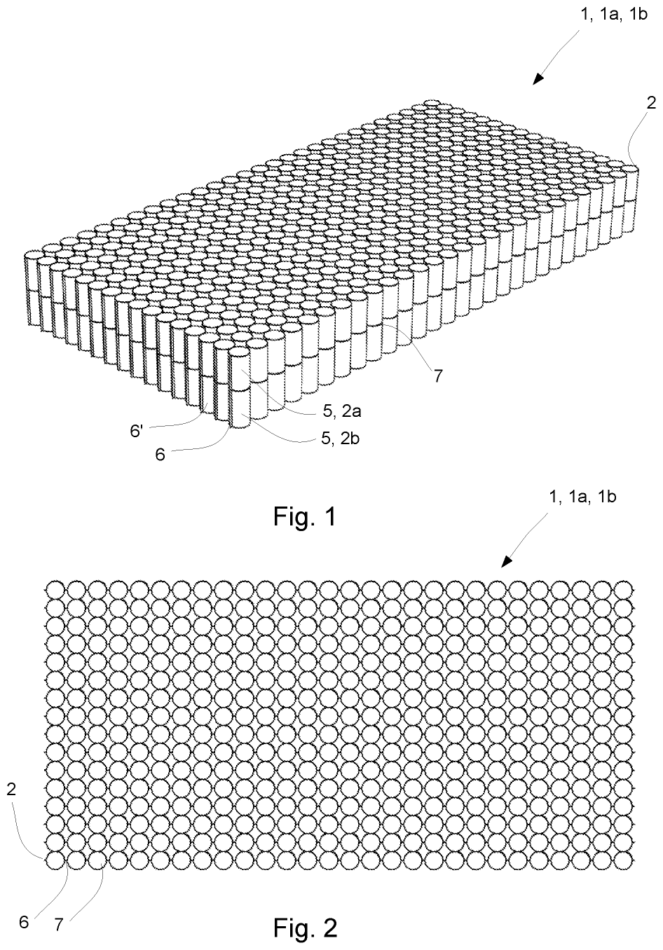

As is seen in FIGS. 1 and 2, the mattress 1 comprises a number of spring strings 2 which are arranged side by side such that they together form the mattress 1. A spring string 2 forms one column of the mattress 1. The spring strings 2 may be attached to each other by means of an adhesive such as hot melt adhesive. Other adhesives are also feasible. The spring strings 2 have a longitudinal extension such that they define the length of the mattress 1, i.e. each spring string 2 extends the full length of the mattress 2.

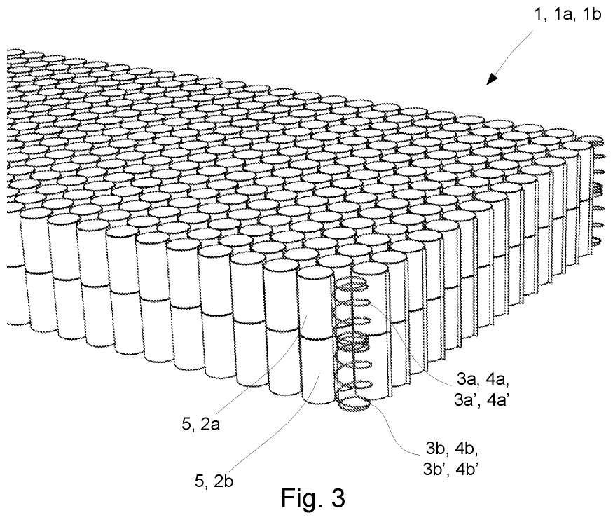

Each spring string 2 further comprises a fabric material 6, which is configured to hold springs 3a, 3b, 4a, 4b (see FIG. 3) in pockets 6′ formed in said fabric material 6.

The fabric material may e.g. be a nonwoven fabric material, preferably a material comprising thermoplastic material or another material which is suitable for ultrasonic welding or friction welding.

The springs 3a, 3b, 4a, 4b are preferably coil springs, but other spring types are also conceivable.

The pockets 6′ enclosing the springs 3a, 3b, 4a, 4b form pocket spring units 5. As can be seen in FIGS. 1 to 3, each spring string 2 comprises an upper layer 2a and a lower layer 2b of pocket spring units 5 being arranged axially above each other. Two pocket spring units 5 arranged axially above each other together form a double layered spring unit 7. The entire mattress 1 thus comprises an upper layer 2a and a lower layer 2b of pocket spring units 5.

In each layer 2a, 2b of a spring string 2, a stiffer frame spring 4a, 4b or a less stiff reference spring 3a, 3b may be arranged which means that each double layer spring unit 7 can be configured in four different ways if four springs with different characteristics are used.

The stiffer frame springs have a spring constant in the range of 15% to 30%, more specifically 20% to 25%, and preferably approximately 25% higher than the reference springs. The increased spring constant can be achieved for instance by increasing the diameter of the wire of the springs 3a, 3b, 4a, 4b. An exemplary diameter for the stiffer frame springs 4a, 4b may be approximately 1,9 mm whilst the reference springs 3a, 3b may have a diameter of approximately 1,7 mm. Furthermore, an increase in spring constant for the stiffer frame spring 4a, 4b could be achieved by removing one coil on each of the stiffer springs 4a, 4b.

To achieve reinforced edges on the mattress 1, stiffer frame springs 4a, 4b are arranged in at least one outermost row in at least one of the layers 2a, 2b along the edge of the mattress 1 which is to be reinforced. This edge will not deflect as much as the rest of mattress 1 for a given load.

The exact use of the stiffer frame springs 4a-bcan of course be varied; in one embodiment each of the edges of the mattress 1, i.e. the entire circumference of the mattress 1, is provided with one row/column of stiffer springs 4a, 4b in at least one of the upper and lower layer 2a, 2b. Furthermore, in a preferred embodiment, two outermost rows/columns with stiffer springs 4a, 4b may be arranged in each layer 2a, 2b and on each edge of the mattress 1, i.e. around the entire circumference of the mattress 1.

It is to be realized that other combinations are also feasible, such as three outermost rows of stiffer frame springs 4a, 4b in the upper and/or the lower layer 2a, 2b along the longitudinal edges of the mattress 1 and two outermost rows of stiffer frame springs 4a, 4b in the upper and/or the lower layer 2a, 2b along the transversal edges.

Each spring string 2 comprises between 14 and 16 double layer spring units 7 per meter of spring string 2, preferably 15 double layer spring units per meter of spring string 2. A mattress 1 of a typical length of 200 cm thus comprises between 28 and 32, preferably 30 double layer springs unit 7 in the longitudinal direction.

Each spring string 2 is attached by means of an adhesive, preferably hot melt adhesive, side by side to another spring string 2. Between 13 to 16 spring strings 2, preferably approximately 14 spring strings 2 together form a pocket spring mattress 1 with a width of 90 cm.

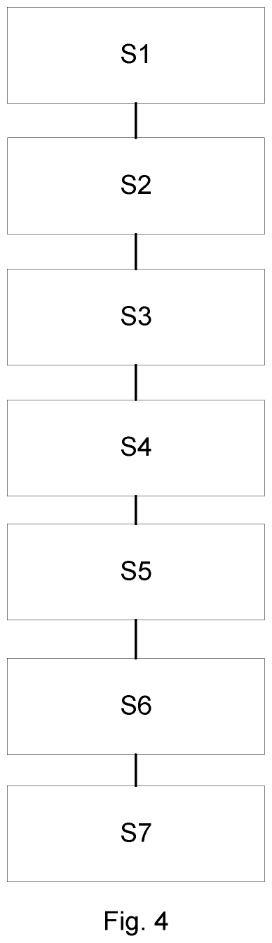

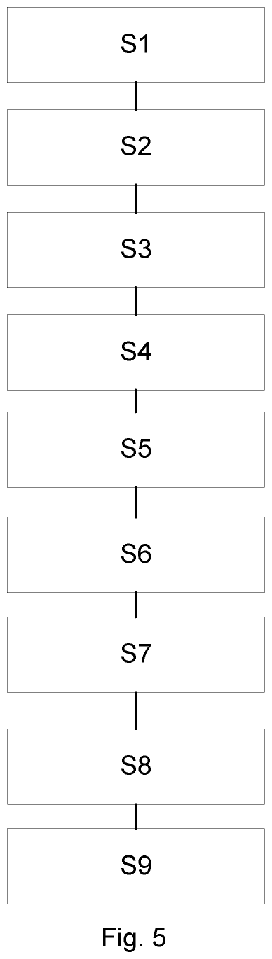

The method of the teachings herein will now be described with simultaneous reference to FIGS. 4 and 5. Each spring 3a, 3b, 4a, 4b is manufactured from a corresponding wire 3a′, 3b′, 4a′, 4b′. The method comprises the steps of determining S1 if a reference wire 3a′ or a stiffer frame wire 4a′ is to be used for the upper layer 2a and if a reference wire 3b′ or a stiffer frame wire 4b′ is to be used for the lower layer 2b. The method also comprises a step S2 of feeding the determined upper layer wire 3a′, 4a′ and the determined lower layer wire 3b′, 4b′, as well as a step S3 of heating the determined wires 3a′, 3b′, 4a′, 4b′. In step S4 the method performs bending the determined upper layer wire 3a′, 4a′ and the determined lower layer wire 3b′, 4b′;, while in step S5 each wire 3a′, 3b′, 4a′, 4b′ is cut to form an upper layer spring 3a, 4a and to form a lower layer spring 3b, 4b. The method also comprises a step S6 of placing each spring 3a, 3b, 4a, 4b in a fabric pocket 5; and a step S7 of sealing the pockets 5 by means of welding, thereby forming a double layered spring unit 7. The springs for the upper layer 2a and the lower layer 2b are thus manufactured simultaneously while enabling the alternation of two separate wires with different characteristics for each of the layers 2a, 2b of the spring string 2. Each spring string 2 can be varied in a large number of ways. For instance, if the transversal edges of the mattress 1 are to be reinforced, a spring string 2 of the mattress 1 can be manufactured containing stiffer springs 4a, 4b only in the first and last double layered spring unit 7.

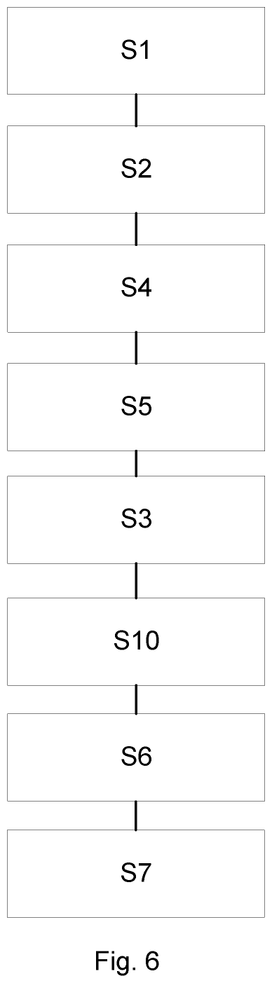

The stiffer springs 4a, 4b may be placed in the upper layer 2a, the lower layer 2b or in both layers 2a, 2b. Alternatively as is seen in FIG. 6, the method could be varied such the step of heating S3 the wire(s) is performed after the cutting step S5 and a cooling step S10 may be added after the heating S3 before placing S6 the springs in the pockets 5 of the fabric material.

I.e. an alternative method could be: determining S1-->feeding S2-->bending S4-->cutting S5-->heating S3-->cooling S10-->placing S6-sealing S7.

It is also to be realized that the pockets 5 may be partially or completely formed before and/or after the springs are placed S6 in the position where each pocket is to be arranged. I.e. the springs could be placed S6 in the pockets 5 of the fabric material before any seam of the pockets 5 is sealed or after that some of the seams of the pockets are sealed and the step of sealing S7 is thereafter performed to complete the formation of each pocket 5.

The upper and lower layer springs 3a, 3b, 4a, 4b may be placed in the same pocket in the fabric material, which is subsequently sealed S7 around and between each spring 3a, 3b, 4a, 4b which forms two pocket spring units 5 arranged axially above one another and together forming a double layer spring unit 7. The sealing of the fabric material is preferably performed by means of ultrasonic welding.

The spring string is in an example cut, in a step S8, when a sufficient number of double layer spring units 7 are formed, for instance between 28 to 32 or preferably 30 double layered spring units 7 for a typical mattress length of 200 cm.

Each spring string 2 may further be attached, in step S9, side by side to another spring string 2 by means of an adhesive such as hot melt and approximately 14 spring strings 2 form a mattress 1 with a typical width of 90 cm.

It should be mentioned that the inventive concept is by no means limited to the embodiments described herein, and several modifications are feasible without departing from the scope of the appended claims. In the claims, the term “comprises/comprising” does not exclude the presence of other elements or steps. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second” etc do not preclude a plurality. Reference signs in the claims are provided merely as a clarifying example and shall not be construed as limiting the scope of the claims in any way.

1. A pocket spring mattress comprising a plurality of double layer spring units arranged in rows and columns to form a rectangular shaped mattress, each double layer spring unit comprising a first pocket spring unit arranged axially onto a second pocket spring unit (2b), and wherein each spring unit comprises a number of springs and a fabric pocket enclosing the springs, said springs comprising reference springs having a first spring constant and frame springs having a second spring constant being greater than the first spring constant, and wherein frame springs are arranged in at least one of the first and second pocket spring units of at least one outermost row or column of the double layered spring units in a configuration such that the edge of the mattress is reinforced.

2. The pocket spring mattress according to claim 1, wherein a series of adjacent double layer spring units are attached to each other to form an elongated spring string.

3. The pocket spring mattress according to claim 2, wherein each spring string is arranged side by side with another spring string forming an upper spring layer formed by the first pocket spring units, and a lower spring layer) formed by the second pocket spring units.

4. The pocket spring mattress according to claim 1, wherein frame springs are arranged in at least one of the first and second pocket spring units of at least two adjacent outermost rows or columns of the double layered spring units.

5. The pocket spring mattress according to claim 1, wherein frame springs are arranged only in the first pocket spring units of two adjacent outermost rows and columns of the double layered spring units, forming a reinforced edge around the circumference of the mattress.

6. The pocket spring mattress according to any one of claim 1, wherein frame springs are arranged only in the second pocket spring units of two adjacent outermost rows and columns of the double layered spring units, forming a reinforced edge around the circumference of the mattress.

7. The pocket spring mattress according to claim 1, wherein frame springs are arranged in the first and second pocket spring units of two adjacent outermost rows and columns of the double layered spring units, forming a reinforced edge around the circumference of the mattress.

8. The pocket spring mattress according to any one of the preceding claim 1, wherein the second spring constant of the frame springs is at least 15%, and preferably at least 30% higher than the first spring constant of the reference springs.

9. The pocket spring mattress according to claim 1, wherein a material of the fabric pocket is a nonwoven fabric material comprising thermoplastic material.

10. The pocket spring mattress according to claim 2, wherein each spring string comprises between 14 and 16 double layer spring units per meter of spring string, preferably 15 double layered spring units per meter of spring string and wherein each spring string is attached by means of an adhesive, preferably hot melt adhesive, side by side to another spring string.

11. A method for manufacturing a plurality of double layer spring units arranged in a spring string configured to form a mattress according to claim 1, wherein the method comprises the steps of:
determining if a reference wire or a frame wire is to be used to form upper spring of the first pocket spring units and if a reference wire or a frame wire is to be used to form lower spring of the second pocket spring units,
feeding the determined upper wire and the determined lower wire,
heating the determined wires,
bending the determined upper wire and the determined lower wire,
cutting each wire to form an upper spring and a lower spring,
placing each spring in a fabric pocket (5), and
sealing the pockets by means of welding forming a double layer spring unit.

12. The method according to claim 11, further comprising arranging the upper spring and the lower spring in a common pocket, and sealing the pocket around the springs and between the upper spring and the lower spring thereby forming one pocket for the upper layer and one pocket for the lower layer, thus forming two pocket spring units together forming the double layer spring unit.

13. The ethod according to claim 11, wherein the fabric material is cut to form a spring string after a predetermined number of double layered spring units are formed.

14. The method according to claim 13, further comprising attaching each spring string by means of an adhesive, preferably hot melt adhesive, or by ultra-sonic welding, side by side to another spring string.

15. The method according to claim 12, further comprising sealing the pockets by means of ultra-sonic welding.
